(19) United States
(12) Patent Application Publication
(10) Pub. No.: US 2010/0032285 A1
(43) Pub. Date: Feb. 11, 2010

(54) METHOD OF PLASMA TREATMENT OF A SURFACE

(75) Inventors: Michael Thomas, Lehrte (DE); Eugen Schlittenhardt, Wolfsburg (DE)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Fraunhofer-Gesellschaft zur Forderung der Angewandten Forschung E.V., Munchen (DE)

(21) Appl. No.: 12/375,783

(22) PCT Filed: Jul. 19, 2007
(86) PCT No.: PCT/EP2007/006615

§ 371 Date: Sep. 29, 2009

(30) Foreign Application Priority Data
Jul. 31, 2006 (DE) 10 2006 036 536.4

(51) Int. Cl. H05H 1/03

(52) U.S. Cl. 204/164

(57) ABSTRACT

The present invention includes methods of plasma treating a surface of an object. A hollow body, which has one wall made of dielectric material, is filled with a process gas and sealed to form a gas-tight inner chamber having an internal pressure of at least 0.5 bar. The hollow body is then positioned in a space between two electrodes. The space has an external pressure of at least 0.5 bar and is filled with a gas which has a higher ignition field strength than the process gas. A plasma is then ignited in the inner chamber of the hollow body by applying a sufficiently high alternating voltage to the electrodes.

### FIELD OF THE INVENTION

The present invention relates to a method for the plasma treatment of a surface in a hollow body.

### BACKGROUND

It is known to treat surfaces with a plasma to obtain modified surface properties. For example, publication DE 43 18 086 A1 discloses a method in which a plasma is ignited within a hollow body. However the disclosed method is relatively complex because the hollow bodies to be treated must first be evacuated to produce sufficiently low internal pressure to ignite a low pressure plasma.

### SUMMARY

In one embodiment, the proposed method comprises the following steps:
filling a hollow body, which has one wall made of dielectric material, with a process gas,
gas-tight sealing the hollow body to form an inner chamber containing a process gas such that the inner chamber has an internal pressure of at least 0.5 bar,
introducing the sealed hollow body into a space with at least two electrodes and an external pressure of at least 0.5 bar prevailing in this space outside the hollow body,
filling the space between the electrodes with a gas which has a higher ignition field strength than the process gas, and
igniting a plasma in the inner chamber of the hollow body by applying a sufficiently high alternating voltage to the electrodes.

As a result of this method, the internal wall surface of the hollow body itself and/or an external surface of an object disposed in the hollow body can be treated, i.e., coated and/or functionalised. Relative to low pressure plasma treatment methods, the method proposed here has low complexity and hence low process and investment costs because, as a result of the relatively high external pressure, a complicated evacuation of a device which is used for implementing the method can be eliminated. This is possible because the plasma is ignited at a relatively high pressure, namely the above-mentioned internal pressure.

By eliminating the complex evacuation requirement, the proposed method can also be integrated very easily in existing process chains and hence can be implemented as a continuous process. Furthermore, the method is exceptionally flexible with respect to the dielectric material used for the hollow body and the geometry of the hollow body. Suitable materials for the wall of the hollow body include in particular polypropylene or another plastic material, glass or ceramics. The hollow body can be configured as a bag, i.e., with flexible walls, a bottle or a canister. The method also consumes a low amount of process gas because the hollow body is filled only once and does not require gas flow to be maintained during burning of the plasma. Consequently, the use of expensive gases, such as for example helium, becomes economical as a process gas.

A typical embodiment of the method provides that a plasma is ignited exclusively in the interior of the hollow body. This is possible because the process gas within the hollow body has a lower ignition field strength (and hence a lower ignition voltage) than the gas present in the space outside of the hollow body.

Embodiments provide that the external pressure and/or the internal pressure is no more than 10 bar such that the production of the plasma does not involve too high of temperatures. Preferably, the external pressure and/or the internal pressure may have values of between 0.8 bar and 2 bar. Pressures in this range can be produced with exceptionally low complexity and permit production of a plasma at relatively low temperatures. The method can be implemented in a particularly simple manner if it is implemented with an external pressure corresponding to atmospheric pressure. The internal pressure can be equal to the external pressure or slightly greater, preferably no more than 1 bar above the external pressure. This allows the hollow body to be filled with the process gas without complex pumping, while at the same time, preventing high internal pressure which could involve too high plasma temperatures and consequently damage to the hollow body. If the internal pressure is at least as great as the external pressure, the method is simplified because the hollow body can be easily filled while, particularly with respect to a hollow body with flexible walls, maintaining the shape of the hollow body.

Typically the hollow body has a wall thickness of between 10 μm and 5 mm, preferably between 50 μm and 2 mm. The hollow body can be dimensioned in particular such that it has a smallest diameter (largest extension in the direction in which the latter is lowest) of at least 2 cm, preferably of at least 6 cm. At these sizes, sufficient process gas is available within the hollow body in order to achieve consistent surface treatment by the plasma without process gas being refilled.

To provide as consistent a surface treatment as possible of the hollow body itself or of an object located therein, the plasma is produced in preferred embodiments of the invention as volume plasma which extends from one wall of the hollow body up to an oppositely-situated wall of the hollow body, and can fill the entire interior of the hollow body.

To produce a plasma of the desired quality, the alternating voltage between the electrodes may have an amplitude voltage of between 0.1 kV and 50 kV, preferably of between 1 kV and 20 kV. An electrical energy of between 100 W and 5 kW may be supplied to ignite and maintain the plasma. It is advantageous for satisfactory surface treatment if parts of the surface to be treated are in contact with the plasma for a duration of between 5 s and 300 s. The hollow body may be moved between the electrodes with a preferably even movement, while the alternating voltage is applied to the electrodes and the plasma is maintained, such that all the parts of the surface to be treated are in contact with the plasma for a suitable duration.

The electrodes can include pins (bars) or at least one pin and one plate or two plates. Use of pins offers an advantage that sufficiently high field strengths can be achieved in a relatively simple manner to initiate a corona discharge, while plates are advantageous to produce a volume plasma of a greater diameter. Consequently, an arrangement in which one electrode is a plate and the second electrode is a pin may be advantageous. A plurality of pins of the same polarity can also be used. For the purpose of a surface treatment which is as consistent as possible, at least one electrode, preferably a pin-shaped electrode or a plurality of pin-shaped electrodes, can be moved while the surface is being treated by the plasma.

An embodiment of the invention provides that the hollow body abuts against at least one electrode after introduction into the space between the electrodes. As a result, the space remaining around the electrode is reduced, which facilitates the plasma burning mainly in the interior of the hollow body.

The process gas inside of the hollow body can include helium, argon or another noble gas, or a gas containing one or more of these noble gases. In this manner a sufficiently low ignition field strength can be achieved in the interior of the hollow body. To achieve a higher ignition field strength outside of the hollow body, a quenching gas such as SF₆ can be used to fill the space between the electrodes outside the hollow body. Alternatively, air or a process gas based on air could be used as process gas.

It may be advantageous to mix in a precursor or a plurality of precursors to the process gas, to provide a desired modification to the treated surface by functionalizing the surface and/or by coating the surface by deposition. In a particularly simple manner, a precursor can be added to the process gas by conducting the process gas or a starting gas for the process gas through the corresponding precursor before filling the hollow body. Depending on the desired effect, very different precursors can be used. For example silicon-based precursors can lead to formation of a migration or diffusion barrier on the treated surface. To achieve more hydrophilic surfaces, e.g., tetramethoxysilane (TMOS) can be used as precursor. By using hexamethyldisiloxane (HMDSO) or possibly also fluorine-containing precursors, hydrophobic or oleophobic surfaces can be produced. Protein-repellent surfaces can be achieved for example by using diethyleneglycol monovinylether as a precursor. Finally, it is possible to use precursors for functionalising the treated surface, said precursors producing amino-, epoxy-, hydroxy- or carboxylic acid groups. Such precursors may produce amino groups for example forming gas, aminopropyltrimethoxysilane (APTMS) or ammonia. Precursors producing epoxy groups include glycidylmethacrylate. Precursors for producing hydroxy groups include oxygen-containing precursors. Precursors for producing carboxylic acid groups include for example maleic acid anhydride or acrylic acid.

A typical embodiment of the described method results in an internal wall surface of the hollow body being coated and/or functionalised. Another advantageous embodiment of the method provides that, instead or additionally, an external surface of one or more objects introduced in advance into the hollow body is treated, in particular coated or functionalised in another manner. For this purpose, the corresponding object can be introduced for example into a bag which, for example by welding, is thereupon sealed so extensively that only a small opening remains for supplying the process gas, whereupon the process gas is filled into the hollow body and the latter is completely sealed. The gas-tight sealing of the hollow body can also be accomplished by closing a valve of the process gas supply (this applies also for the embodiment of the method in which merely the internal wall surface of the hollow body is treated).

Of course, containers of a type other than hollow bodies can be used for such methods for the treatment of an external surface of objects. The object to be treated can concern for example a stopper or a microtitre plate. In order to achieve a consistent surface treatment of such an object, which treatment reaches the object on every side, the object may be moved by shaking the hollow body during burning of the plasma.

If the proposed method is used for coating objects in hollow bodies, the objects can remain in the hollow body to serve as packing (surface-treated from the inside). In addition, it is possible to empty the hollow body subsequently by suction to achieve a vacuum packing. Both the packed object and the vacuum packing itself can be endowed with desired surface properties by the method.

### BRIEF DESCRIPTION OF THE DRAWINGS

Embodiments of the invention described here are explained subsequently with reference to FIGS. 1 to 5.

FIG. 1: an arrangement for implementing a method according to one embodiment of the invention with two planar electrodes;

FIG. 2: another arrangement for implementing such a method with one bar electrode and one planar electrode,

FIG. 3: another arrangement with two bar electrodes,

FIG. 4: another arrangement for implementing a comparable method with electrodes abutting on a hollow body and

FIG. 5: an example of a hollow body used for implementing a method according to the invention with two objects to be treated.

An arrangement is illustrated in FIG. 1 which has a first electrode 1, and a second electrode 2 each of which are plate-shaped and disposed parallel to each other. Dielectric 3 is disposed on second electrode 2. Between the first electrode 1 and the second electrode 2, an electrical alternating voltage of, for example about 1 kV to 20 kV amplitude voltage and a frequency in the range between about 10 kHz and 60 kHz can be applied. In the case of the method to be implemented with this arrangement for the plasma treatment of an internal wall surface of a hollow body 4 which has a wall made of, for example, polypropylene, this hollow body 4 is filled firstly with a process gas, for example helium, after which the hollow body 4 is sealed in a gas-tight manner by welding together. The hollow body 4 may be a bag with flexible walls of a wall thickness of approx. 100 μm. Corresponding methods can also be implemented with other hollow bodies, such as for example bottles or canisters.

The sealed hollow body 4 is then introduced into a space 5 between the first electrode 1 and the second electrode 2. In one embodiment, the space 5 has an external pressure of approximately 1 bar, more precisely atmospheric pressure, around the hollow body 4. Within the hollow body 4, a slightly higher internal pressure may be present, as a result of which the hollow body 4 maintains its shape. The space 5 between the electrodes 1 and 2 is filled with a gas, in the present case, with air which has a higher ignition field strength than the helium used as process gas. After penetration of the hollow body 4 into the mentioned space 5, a plasma is produced in the interior of the hollow body 4. Because of the lower ignition field strength of the process gas in the interior of the hollow body 4 by means of the alternating voltage applied between the electrodes 1 and 2, the plasma modifies the internal wall surface of the hollow body 4.

The wall of the hollow body 4 may be formed from a dielectric material, for example a plastic material, glass or ceramics. In the present case, the hollow body 4 has a small diameter, corresponding to an extension in the vertical direction, of approximately 7 cm. The plasma produced by the alternating voltage creates a volume plasma 6 which fills the entire interior of the hollow body 4 and extends in particular from one wall of the hollow body 4 up to a wall of the hollow body 4 situated opposite the latter. In order to ignite and maintain this volume plasma 6, an electrical energy of approximately 500 watt is supplied presently into the system.

The lower ignition field strength within the hollow body 4 in comparison to the ignition field strength in the space 5 around the hollow body is achieved because the hollow body 4 is filled with helium. Another process gas such as argon or a different noble gas or gases containing one or more of these noble gases may also be suitable. Alternatively or additionally, the space 5—which is filled with air in one embodiment of the invention—can be filled also by a quenching gas, for example SF₆, around the hollow body 4 to ensure that a plasma is ignited exclusively in the interior of the hollow body 4.

Additionally, a precursor or a plurality of precursors can be mixed into the process gas with which the hollow body 4 is filled. For example, the helium serving as the basis for the process gas may be conducted through the corresponding precursor before filling the hollow body 4 with process gas. Suitable precursors include silicon-based precursors, such as e.g., TMOS, HMDSO, fluorine-containing precursors, amino-, epoxy-, hydroxy-, or precursors producing carboxylic acid groups or diethyleneglycol monovinylether. According to the type of precursor used or precursors used, the treated surface in the hollow body 4 can obtain properties.

FIG. 2 shows an arrangement for an alternate method. Recurring features use the same reference numbers. In this embodiment, the first electrode 1, in contrast to the second electrode 2, is configured here in a bar shape or pin shape. In the case of this arrangement, high electrical field strengths can be achieved in the space 5 very easily, which facilitates ignition of the plasma in the hollow body 4. Additionally, the volume plasma 6 does not fill the hollow body 4 completely. To achieve a consistent coating of the entire internal wall surface of the hollow body 4, the hollow body 4 is moved through the arrangement as shown by double arrow 7. Alternatively or additionally, the first electrode 1 can also be moved to achieve a consistent treatment of the surface and to avoid formation at higher temperatures. Instead of the pin-shaped first electrode 1, also a plurality of pin-shaped or bar-shaped electrodes could be used.

Another arrangement for an implementation of a comparable method is represented in FIG. 3, in which both the first electrode 1 and the second electrode 2 are configured in a pin-shape or as a bar electrode.

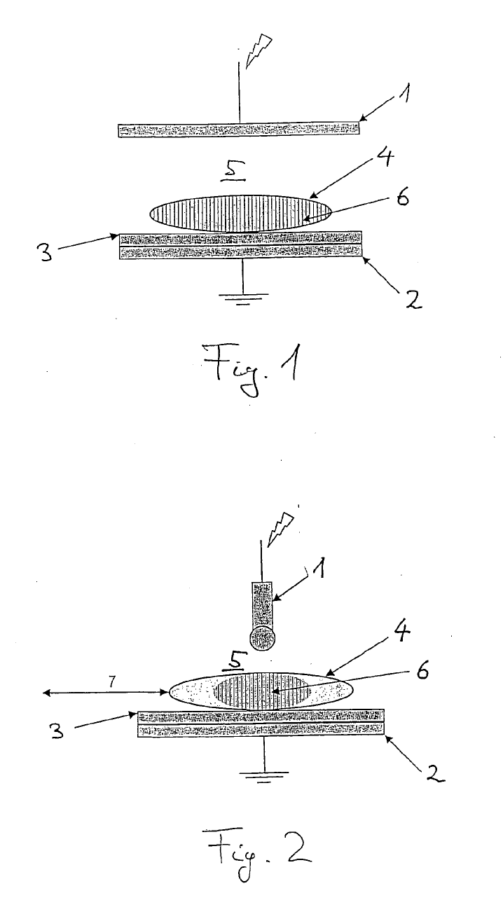

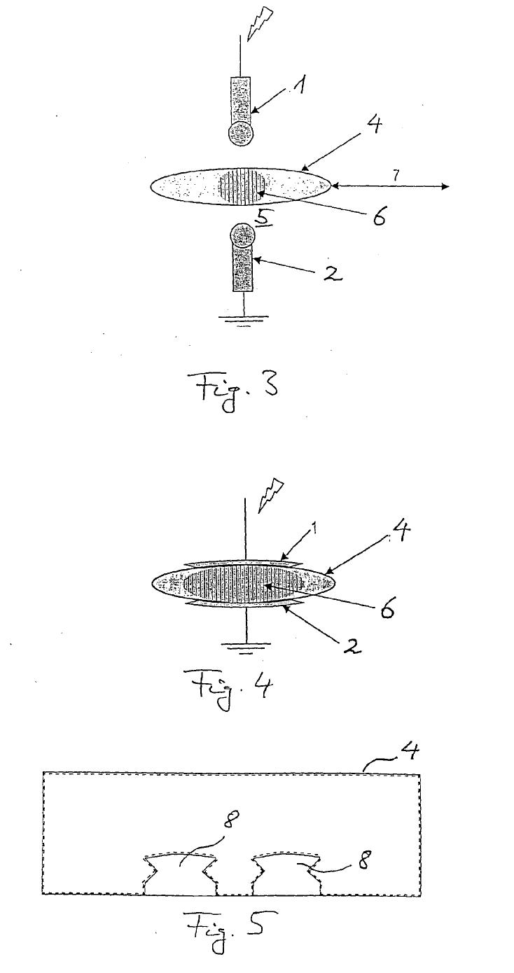

In FIG. 4, the electrodes 1 and 2 are configured such that they abut directly on an external surface of the hollow body 4.

In the case of the previously described embodiments, the proposed method serves to modify, i.e. coat and/or for functionalise, an internal wall surface of the hollow body 4 which can be for example a packing material. A modification of the described methods provides that, before filling the hollow body 4 with the respective process gas, an object, for example a stopper or a microtitre plate, is introduced into the hollow body 4 to modify, i.e. coat and/or functionalise, an external surface of this object.

FIG. 5 shows a hollow body 4 into which two stoppers 8 are introduced as objects to be coated. A coating which is formed during a plasma treatment of the described type by introducing this hollow body 4 with the stoppers 8 into an electrical alternating field is represented in broken lines. Parts of the external surfaces of the stoppers 8 which abut against the internal wall surface of the hollow body 4 are initially left blank. To achieve a complete coating of the stoppers 8 from all sides, the stoppers 8 are moved during the plasma treatment, for example by a shaking movement of the hollow body 4, such that all sides of the stoppers 8 are subjected to the plasma. Sealing the hollow body 4 after filling with the process gas can take place by closing a valve in a process gas supply. Instead of the stoppers 8, objects of a different type and (preferably three-dimensional) shape can be treated, which should comprise dielectric materials in preferred embodiments of methods according to the invention. A development of the method finally provides that the objects treated in the described manner remain subsequently in the hollow body 4 which then serves as packing for the treated objects. The process gas can be suctioned out of the hollow body 4 after the described method to produce a vacuum packing.

Three application examples are described subsequently in detail.

a) Permanent Modification of the Surface Tension:

By introducing helium through a liquid precursor in a bubbler system, a plastic material bag or plastic tube made of polypropylene is filled with the process gas. TMOS is used as a precursor for producing hydrophilic layers and some oxygen is added in addition. The plastic material bags made of polypropylene or the plastic tubes are treated at a power of 300 watt during a duration of approximately 10 seconds. The surface tension of a wall of the plastic material bag or plastic tube thereby rises from 34 mN/m to a value of more than 56 mN/m.

For producing hydrophobic layers, HMDSO is used as precursor in a corresponding method. The plastic material bag or plastic tubes made of polypropylene are treated again at a power of approx. 300 watt such that each part of the surface to be treated is subjected to the plasma during a duration of approximately 20 seconds. The surface energy then drops from 34 mN/m to a value of less than 18 mN/m

b) Production of Functional Groups:

In a medical culture bag, helium and APTMS are introduced. The culture bag is treated at a power of approximately 500 watt over a duration of approximately 20 seconds with a plasma which fills the entire culture bag. After opening the bag, an inner surface of the bag is examined by means of IR spectroscopy. An infrared spectrum with bands for silicon oxide—and also for amino groups is revealed. For example bio-molecules can now couple to these groups.

c) Layers on Different Components

Microtitre plates or natural rubber stoppers are placed in a polyethylene bag, after which the polyethylene bag is filled with a gas mixture comprising helium and HMDSO. The polyethylene bag is then closed and treated at a power of 500 watt such that a plasma burns in its interior over a duration of approx. 10 seconds. Thereafter the polyethylene bag is filled again and treated again in the same way. The surface energy on an internal side of the bag is thereafter less than 18 mN/m and, on the microtitre plate or the stopper, coatings produced by the plasma can be detected everywhere, in addition to the hydrophobic properties, by means of IR spectroscopy

With the invention described here, an advantageously simple method which can be produced without high process gas consumption is proposed for the plasma treatment of a surface in a hollow body. As discussed in detail above, the method comprises the following method steps, preferably in the sequence of their naming:
filling a hollow body which has one wall made of dielectric material with a process gas,
gas-tight sealing the hollow body to provide an internal chamber having an internal pressure of at least 0.5 bar,
introducing the hollow body into a space between at least two electrodes having an external pressure of at least 0.5 bar, wherein the space between the electrodes is filled with a gas which has a higher ignition field strength in the case of the external pressure than the process gas in the case of the internal pressure, and
igniting a plasma in the interior of the hollow body, which is sealed in a gas-tight manner, by applying a sufficiently high alternating voltage between the electrodes, whereon no process gas flow is maintained whilst the plasma burns.

The last mentioned feature is not thereby intended of course to imply that no current movement of the process gas could occur in the hollow body but rather that process gas is neither supplied nor flows out of the hollow chamber during burning of the plasma.

1-23. (canceled)

24. A method for plasma treating a surface in a hollow body comprising:
filling a hollow body having at least one wall made of dielectric material with a process gas;
sealing the hollow body to provide a gas-tight internal chamber having an internal pressure of at least about 0.5 bar;
introducing the hollow body into a space between at least two electrodes, wherein the space has an external pressure of at least 0.5 bar and is filled with a gas having a higher ignition field strength than the process gas; and
applying a sufficiently high alternating voltage between the electrodes to ignite a plasma in the internal chamber of the hollow body.

25. The method of claim 24, wherein the external pressure is less than or equal to the internal pressure.

26. The method of claim 24, wherein the plasma is produced exclusively in the internal chamber of the hollow body.

27. The method of claim 24, wherein the external pressure of the space or the internal pressure of the internal chamber is between 0.5 and 10 bar.

28. The method of claim 24, wherein the external pressure of the space or the internal pressure of the internal chamber is between 0.8 bar and 2 bar.

29. The method of claim 24, wherein the external pressure comprises atmospheric pressure.

30. The method of claim 24, wherein the internal pressure is equal to, or no more than 1 bar above, the external pressure.

31. The method of claim 24, wherein the hollow body comprises a bag, a bottle or a canister.

32. The method of claim 24, wherein the hollow body has a wall thickness of between 10 μm and 5 mm.

33. The method of claim 24, wherein the hollow body has a wall thickness of between 50 μm and 2 mm.

34. The method of claim 24, wherein the hollow body has a smallest diameter of at least 2 cm.

35. The method of claim 24, wherein the hollow body has a smallest diameter of at least 6 cm.

36. The method of claim 24, wherein the plasma comprises volume plasma which extends from one wall of the hollow body to an oppositely-situated wall of the hollow body.

37. The method of claim 24, wherein the alternating voltage has an amplitude of between 0.1 kV and 50 kV.

38. The method of claim 24, wherein the alternating voltage has an amplitude of between 1 kV and 20 kV.

39. The method of claim 24, further comprising supplying a power of between 100 W and 5 kW to produce the plasma.

40. The method of claim 24, wherein the portions of the surface to be treated are contacted with the plasma for a duration of between 5 s and 300 s.

41. The method of claim 24, wherein the electrodes comprise at least one pin and at least one plate electrode, at least two pin electrodes or at least two plate electrodes.

42. The method of claim 24, wherein at least one of the electrodes contacts the hollow body.

43. The method of claim 24, wherein at least one of the electrodes is moved while the voltage is applied.

44. The method of claim 24, wherein the process gas comprises helium, argon, another noble gas, or combinations thereof.

45. The method of claim 24, wherein at least one precursor is mixed into the process gas.

46. The method of claim 45, wherein the at least one precursor is added to the process gas by conducting the process gas through the precursor before filling the hollow body.

47. The method of claim 24, wherein an internal wall surface of the hollow body is coated or functionalized by the plasma.

48. The method of claim 24, wherein an external surface of an object introduced into the hollow body before sealing the hollow body is treated.

49. The method of claim 48, wherein the object is a stopper or microtitre plate.

50. The method of claim 48, wherein the object is moved by moving the hollow body while the external surface thereof is treated with the plasma.
